(19) United States
(12) Patent Application Publication
(10) Pub. No.: US 2009/0237831 A1
(43) Pub. Date: Sep. 24, 2009

(54) STORAGE DEVICE, MAGNETIC CIRCUIT, AND ACTUATOR

(75) Inventor: Yoshihiro Arikawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/477,697

(22) Filed: Jun. 3, 2009

Related U.S. Application Data
(63) Continuation of application No. PCT/JP2006/325757, filed on Dec. 25, 2006.

(51) Int. Cl. G11B 21/02

(52) U.S. Cl. 360/75; G9B/21.003

(57) ABSTRACT

When impact occurs, a magnetic disk device detects the impact, being transmitted to a head, on an actuator located in a route from an impact source to the head. Upon detection of the impact, the magnetic disk device stops data write operation. Specifically, before the impact is transmitted to the head and errors occur in the write operation, the magnetic disk device detects the impact on the actuator located in the route from the impact source to the head, and stops the write operation.

### CROSS-REFERENCE TO RELATED APPLICATION(S)

This application is a continuation of PCT international application Ser. No. PCT/JP2006/325757 filed on Dec. 25, 2006 which designates the United States, the entire contents of which are incorporated herein by reference.

### FIELD

The embodiments discussed herein are directed to a storage device, a magnetic circuit, and an actuator.

### BACKGROUND

In recent years, with increase in recording capacity of storage devices (e.g., magnetic disk devices or drives) each writing data to a storage medium with a head, storage density of storage media has been improved. Accordingly, improvement in accuracy of writing data to storage media has become important. In a magnetic disk device or drive, when a magnetic disk rotates and starts writing or reading data, the temperature inside the magnetic disk device gradually rises. As the temperature rises, parts made of different materials are displaced differently due to the difference in their thermal expansion coefficients, causing distortion. Then, when the distortion is removed, impact and vibration occur. Similarly, when the ambient temperature rapidly changes, distortion occurs because each part follows the ambient temperature differently. Then, when the distortion is removed, impact and vibration occur. Due to the impact and the vibration transmitted to an actuator driving the head, errors may occur in data write operation. Thus, the occurrence of the impact and the vibration needs to be detected to prevent such data write errors.

To detect impact and vibration, technologies have been developed that provide a printed circuit board with a sensor detecting impact, and that stop write operation when the sensor detects impact and vibration. Japanese Laid-open Patent Publication No. 11-53856 discloses a technology that stops write operation by detecting external impact with a sensor provided on a suspension.

The above technologies that provide a sensor on a printed circuit board are useful for detecting external impact and vibration. However, as to impact and vibration caused by internal parts as described, the impact and the vibration are transmitted to the head before transmitted to the sensor, when the parts causing the impact and the vibration are provided at a side opposite the sensor with the head in between. This poses a problem that the impact and the vibration cannot be detected reliably before transmitted to the head.

In the technology disclosed in Japanese Laid-open Patent Publication No. 11-53856, the sensor is provided on the suspension. Thus, the weight of the sensor is applied to a spring that absorbs the impact on the suspension and controls the vibration of the head. This affects the elastic force of the spring, failing to control the vibration of the head.

### SUMMARY

According to an aspect of an embodiment, a storage device for writing data to a storage medium with a head, includes a suspension that supports the head; a drive mechanism that includes an actuator connected to the suspension and moving the head, and a magnetic circuit controlling movement of the actuator; and an impact detection unit that detects impact caused due to change in ambient temperature of the storage device, wherein the impact detection unit is provided on the drive mechanism.

Additional objects and advantages of the invention (embodiment) will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory and are not restrictive of the invention, as claimed.

### BRIEF DESCRIPTION OF DRAWING(S)

FIG. 1 is a drawing for explaining an overview and characteristics of a magnetic disk device according to a first embodiment;

FIG. 2 is a schematic of the magnetic disk device depicted in FIG. 1;

FIG. 3 is a schematic of an actuator depicted in FIG. 2;

FIG. 4 is a diagram for explaining an impact sensor depicted in FIG. 2;

FIG. 5 is a schematic of a magnetic circuit depicted in FIG. 2;

FIG. 6 is a schematic of a magnetic disk device according to a second embodiment; and

FIG. 7 is a schematic of the magnetic disk device depicted in FIG. 6.

### DESCRIPTION OF EMBODIMENT(S)

Exemplary embodiments of a magnetic disk device or drive according to the present invention are described in detail with reference to the accompanying drawings.

The following describes an overview and characteristics of a magnetic disk device according to a first embodiment, and a structure of the magnetic disk device, followed by advantages of the first embodiment.

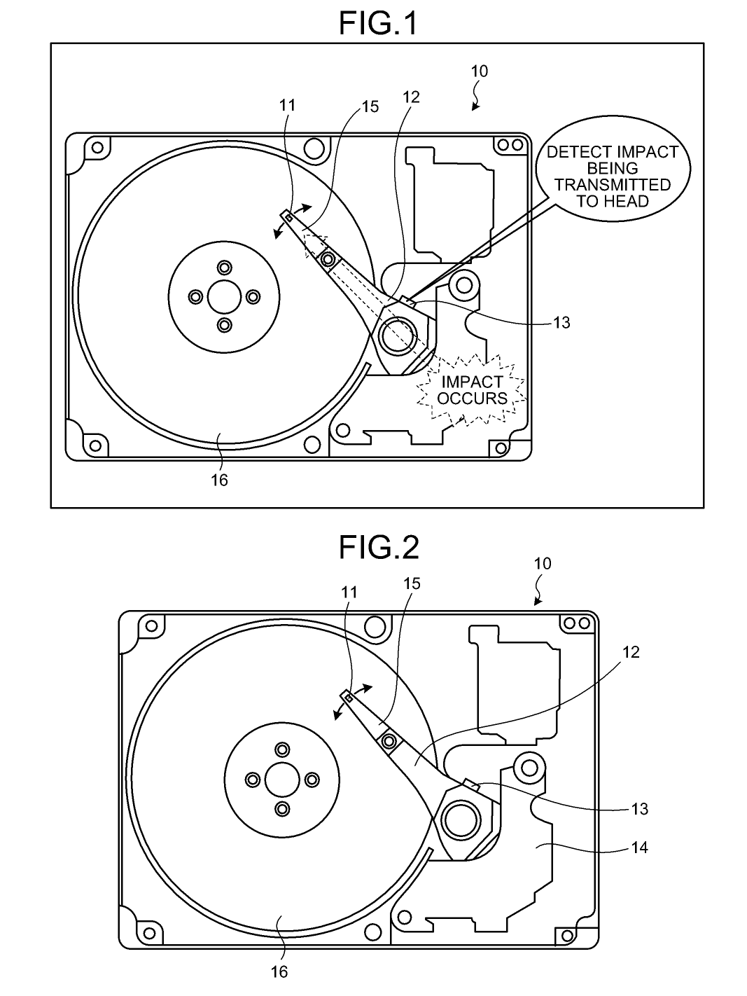

Referring to FIG. 1, the following describes an overview and characteristics of a magnetic disk device according to the first embodiment. FIG. 1 is a drawing for explaining an overview and features of a magnetic disk device according to the first embodiment.

A magnetic disk device 10 according to the first embodiment is configured to write data to a storage medium with a head. The magnetic disk device 10 has a main feature of detecting impact reliably before the impact is transmitted to the head, and controlling the vibration of the head.

To describe the main feature specifically, as depicted in FIG. 1, the magnetic disk device 10 according to the first embodiment includes a head 11 that reads and writes data from and to a magnetic disk 16, an actuator 12 that is connected to a suspension supporting the head 11 and is arranged to be rotatable about a shaft thereof, an impact sensor 13 provided near the shaft on the actuator 12, and a suspension 15 that includes a spring controlling the vibration of the head 11.

With this structure, when impact occurs, the magnetic disk device 10 detects the impact, being transmitted to the head 11, on the actuator 12 located in a route from an impact source to the head 11. Specifically, when distortion occurs in parts having different thermal expansion coefficients inside the device according to the change in ambient temperature, the magnetic disk device 10 detects internal impact and vibration having high frequency components and caused upon removal of the distortion.

Upon detecting the impact, the magnetic disk device 10 stops data write operation. Specifically, before the impact is transmitted to the head 11 to cause errors in write operation and data lost, the magnetic disk device 10 detects the impact on the actuator 12 located in a route from an impact source to the head 11, and stops the write operation.

In this manner, the magnetic disk device 10 detects the impact, being transmitted to the head 11, on the actuator 12 located in a route from an impact source to the head 11. Thus, the impact is detected reliably before transmitted to the head 11 as described in the main feature. Further, the impact sensor 13 is provided on the actuator 12, so that no weight is applied to the spring that absorbs the impact and controls the vibration of the head 11. Thus, the vibration of the head 11 is controlled.

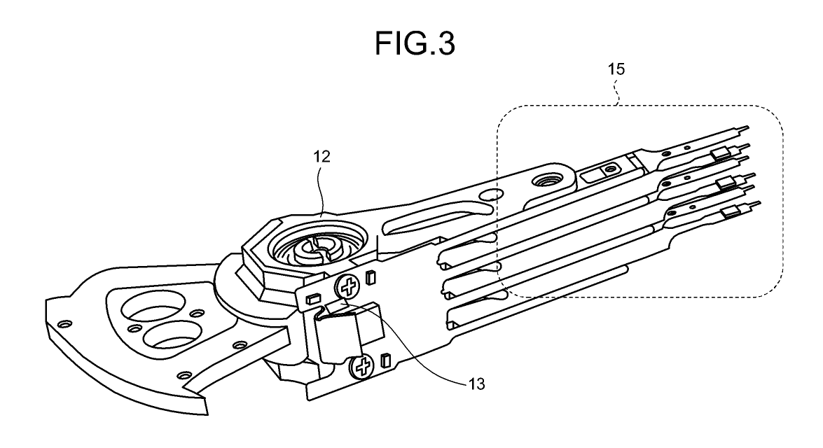

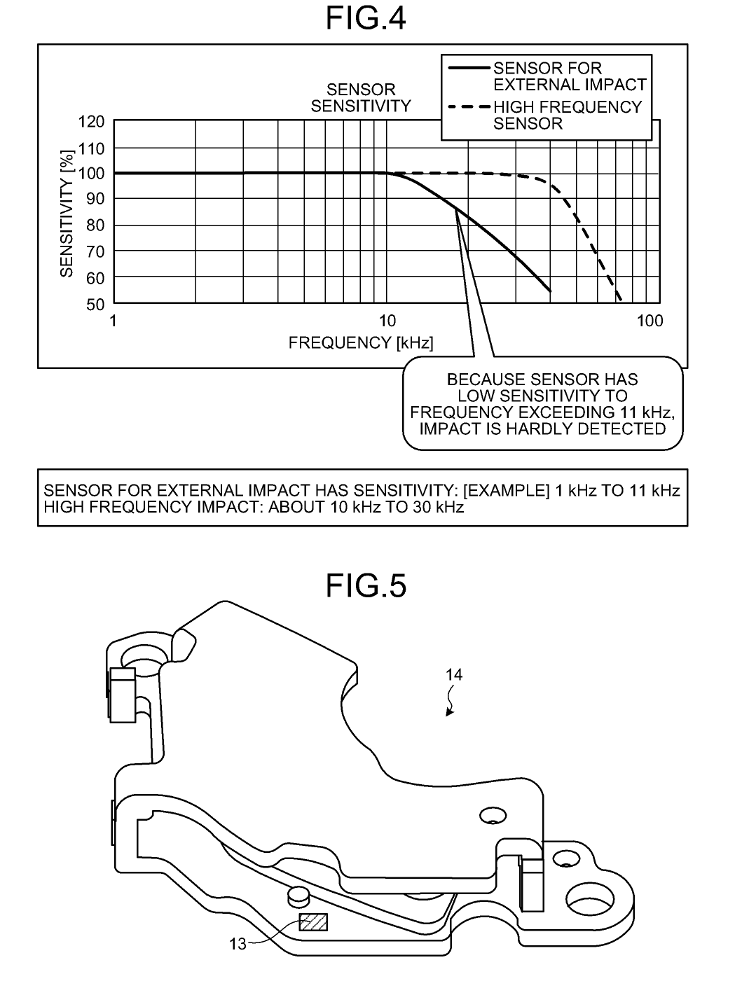

Referring to FIGS. 2 to 4, the following describes a structure of the magnetic disk device 10 depicted in FIG. 1. FIG. 2 is a schematic of the magnetic disk device 10 according to the first embodiment, FIG. 3 is a schematic of an actuator, and FIG. 4 is a diagram for explaining an impact sensor. As depicted in FIG. 2, the magnetic disk device 10 includes the head 11, the actuator 12, the impact sensor 13, a magnetic circuit 14, the suspension 15, and the magnetic disk 16. Procedures performed by these units are now described.

The head 11 reads and writes data from and to the magnetic disk 16. Specifically, the head 11 supported by the suspension 15 (described later) stops data write operation when impact is detected by the impact sensor 13. In the head 11 is installed an electromagnetic conversion element including a read element and a write element.

In the actuator 12 is provided the impact sensor 13. The actuator 12 is connected to the suspension 15 supporting the head 11, and rotates about the shaft. Specifically, as depicted in FIG. 3, the impact sensor 13 is provided near the shaft on the actuator 12. The actuator 12 includes a printed circuit board (not depicted in the drawings), and the impact sensor 13 is connected to a wire provided on the printed circuit board.

The impact sensor 13 is provided near the shaft on the actuator 12. When impact occurs, the impact sensor 13 detects the impact, being transmitted to the head 11, on the actuator 12 located in a route from an impact source to the head 11. Specifically, the magnetic disk device 10 is connected to a wire near the shaft on the actuator 12. When distortion occurs in parts having different thermal expansion coefficients according to the change in ambient temperature, the magnetic disk device 10 detects internal impact and vibration having high frequency components caused upon removal or relief of the distortion.

Referring to FIG. 4, the following describes the impact sensor 13 in detail. As depicted in FIG. 4, the impact sensor 13 has a sensitivity for detecting high frequencies between 10 kHz and 30 kHz. Assume that an impact exceeding a separately specified impact slice value (e.g., 1 G) at 20 kHz is applied. In this case, the impact sensor 13 sends a signal to stop data write operation to the head 11.

Internal high frequency impact having high frequency components between 10 kHz and 30 kHz for example, and external impact between 1 kHz and 11 kHz for example largely differ from each other regarding frequency bands of their core impacts. For this reason, an impact sensor set to detect the frequency band of 1 kHz to 11 kHz corresponding to the external impact cannot detect internal high frequency impact. Thus, the impact sensor 13 is set to detect impact having high frequency components.

The suspension 15 is connected to the actuator 12, and supports the head 11 at an end thereof. The suspension 15 includes a spring that controls the vibration of the head 11, and the spring absorbs the impact being transmitted to the head 11.

The magnetic disk 16 is a storage medium including a magnetic layer formed on a disk-shaped substrate made of metal or glass. To record data to the magnetic disk 16, the head 11 applies a magnetic field to a recording area in which data is recorded on the magnetic disk 16. The head 11 then changes the magnetized state of the magnetic layer on a surface of the substrate, so as to record the data. On the other hand, to read and reproduce data from the magnetic disk 16, the head 11 is moved to the recording area on the magnetic disk 16 being reproduced. Then, the magnetized state of the magnetic layer on the magnetic disk 16 is read, so that the data is reproduced.

As described, according to the first embodiment, the impact sensor 13 detecting impact is provided on the actuator 12, so that the impact being transmitted to the head 11 is detected on the actuator 12 located in a route from an impact source to the head 11. Thus, the impact is detected reliably before transmitted to the head 11.

According to the first embodiment, the impact sensor 13 detects impact having high frequency components. Thus, when distortion occurs in parts having different thermal expansion coefficients inside the device according to the change in ambient temperature, internal impact is detected that includes high frequency components, and that is caused upon removal of the distortion.

According to the first embodiment, the impact sensor 13 is provided on the actuator 12 that is connected to the suspension 15 supporting the head 11, and that is arranged to be rotatable about the shaft. Thus, the impact being transmitted to the head 11 is reliably detected.

According to the first embodiment, the impact sensor 13 is provided near the shaft of the actuator 12. Thus, the impact sensor 13 is less affected by rotation movement of the actuator 12.

According to the first embodiment, the impact sensor 13 is connected to a wire provided on the printed circuit board of the actuator 12. This eliminates the need to provide a new wire for connecting the impact sensor 13, achieving cost reduction.

The foregoing describes the first embodiment. The present invention may be embodied in various different forms other than the above embodiment. The following describes another embodiment of the present invention as a second embodiment.

In the first embodiment, the impact sensor 13 is provided on the actuator 12. The present invention is not limited to this, and the impact sensor 13 may be provided on the magnetic circuit 14. Specifically, as depicted in FIG. 5, the impact sensor 13 is embedded in a yoke member constituting the magnetic circuit 14.

As such, the sensor is provided on the magnetic circuit. Thus, when distortion occurs in the yoke member itself due to, for example, the thermal expansion difference of the magnet and the yoke member and impact is caused upon removal of the distortion, the impact is detected immediately.

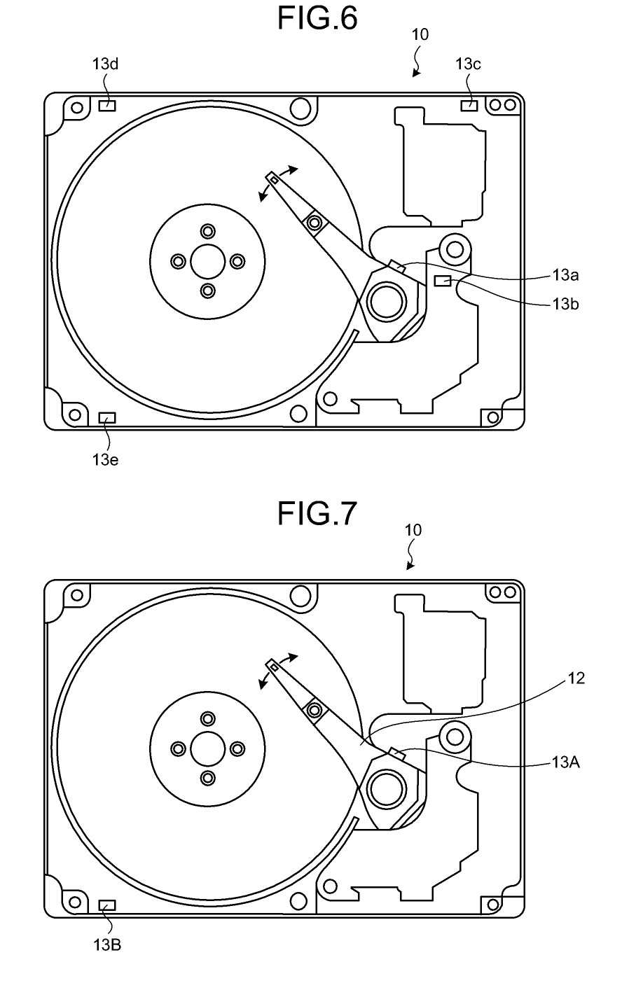

In the first embodiment, only one impact sensor 13 is provided in the magnetic disk device 10. The present invention is not limited to this, and a plurality of impact sensors 13a to 13e may be provided in the magnetic disk device 10. Specifically, as depicted in FIG. 6, the magnetic disk device 10 includes the impact sensors 13a to 13e and detects impact at each position. When either of the impact sensors 13a to 13e detects impact, the magnetic disk device 10 stops the data write operation performed by the head 11.

In this manner, the impact sensors 13 are provided at a plurality of positions, and detect the impact at the respective positions. Thus, the impact is detected more accurately.

In the first embodiment, one impact sensor 13 provided in the magnetic disk device 10 is set to have a predetermined sensitivity. The present invention is not limited to this, and the impact sensors 13a to 13e may be provided in the magnetic disk device 10 and set to detect the impact of different frequencies.

Specifically, as depicted in FIG. 7, the magnetic disk device 10 includes an impact sensor 13A provided on the actuator 12, and an impact sensor 13B provided on a housing main body. To detect the impact mainly having high frequency components, the impact sensor 13A on the magnetic disk device 10 is set to have a sensitivity for detecting a frequency band of, for example, 10 kHz to 30 kHz. On the other hand, the impact sensor 13B is set to detect a frequency band of, for example, 1 kHz to 11 kHz corresponding to external impact.

In this manner, the impact sensors 13 are set to detect the impact of different frequencies depending on the set positions thereof. For example, the impact sensor 13 provided near the actuator 12 is set to detect the impact having high frequency components. In this way, the impact having high frequency components caused by the actuator 12 is detected properly.

In the present invention, a filtering process may be performed to detect the impact of a predetermined frequency band. Specifically, the magnetic disk device 10 filters the impact using a high-pass filter or a low-pass filter and then detects the impact. Then, the magnetic disk device 10 determines a process for controlling the head 11, depending on the type of the detected impact.

As to the processes described in the present embodiment, all or part of the processes described as being performed automatically can be performed manually. Alternatively, as to the processes described as being performed manually, all or part of the processes can be performed automatically by known methods. In addition, processing procedures, controlling procedures, specific names, information including various kinds of data and parameters described in the specification and the accompanying drawings can be changed in any way unless otherwise specified. For example, the impact sensor 13 may be set to detect the impact of a predetermined frequency band.

According to the embodiments, the impact being transmitted to a head is detected on the drive mechanism located in a route from an impact source to the head. Thus, the impact is reliably detected before transmitted to the head.

According to the embodiments, distortion occurs in parts having different thermal expansion coefficients inside the device in accordance with the change in ambient temperature. Then, when the distortion is removed, internal impact having high frequency components occurs and is detected.

A magnetic circuit is relatively large in weight among parts constituting the magnetic disk device. Thus, when impact and vibration occur in the magnetic circuit due to the difference in their thermal expansion coefficients, the impact and the vibration are expected to be large accordingly. According to the embodiments, for example, due to the difference in thermal expansion coefficients of a yoke member and a magnet in the magnetic circuit, distortion occurs in the parts. Then, when the distortion is removed and impact occurs accordingly, the impact is immediately detected.

According to the embodiments, the impact being transmitted to the head is reliably detected.

According to the embodiments, the sensor is less affected by rotation movement of the actuator.

According to the embodiments, a wire provided on a printed circuit board eliminates the need to provide a new wire for connecting the sensor, achieving cost reduction.

According to the embodiments, the impact is detected more accurately.

According to the embodiments, for example, the sensor provided near the actuator is set to detect the impact having high frequency components. Accordingly, the impact having high frequency components and caused by the actuator are detected properly.

According to the embodiments, for the impact caused by the head being driven for example, a filtering process is performed so that the impact is not detected.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A storage device for writing data to a storage medium with a head, the storage device comprising:
a suspension that supports the head;
a drive mechanism that includes an actuator connected to the suspension and moving the head, and a magnetic circuit controlling movement of the actuator; and
an impact detection unit that detects impact caused due to change in ambient temperature of the storage device, wherein
the impact detection unit is provided on the drive mechanism.

2. The storage device according to claim 1, wherein the impact detection unit detects impact having a high frequency component.

3. The storage device according to claim 1, wherein the impact detection unit is provided on the magnetic circuit.

4. The storage device according to claim 1, wherein the impact detection unit is provided on the actuator.

5. The storage device according to claim 4, wherein the impact detection unit is provided near a shaft of the actuator arranged to be rotatable about the shaft.

6. The storage device according to claim 4, wherein the impact detection unit is connected to a wire provided on a printed board of the actuator.

7. The storage device according to claim 1, wherein the impact detection unit is provided at a plurality of positions and detects impact at the respective positions.

8. The storage device according to claim 1, wherein the impact detection unit is set to detect impact of a different frequency depending on each set position.

9. The storage device according to claim 1, wherein the impact detection unit detects only impact of a predetermined frequency band.

10. A magnetic circuit for controlling an actuator to move to a predetermined position, the actuator being connected to a suspension supporting a head that writes data to a storage medium and arranged to be rotatable about a shaft thereof, the magnetic circuit comprising:
an impact detection unit that detects impact caused due to change in ambient temperature of the magnetic circuit, the impact detection unit being provided at a predetermined position on the magnetic circuit.

11. An actuator connected to a suspension supporting a head that writes data to a storage medium and arranged to be rotatable about a shaft thereof, the actuator comprising:
an impact detection unit that detects impact caused due to change in ambient temperature of the actuator, the impact detection unit being provided at a predetermined position on the actuator.
